(19) United States
(12) Patent Application Publication
(10) Pub. No.: US 2012/0173921 A1
(43) Pub. Date: Jul. 5, 2012

(54) REDUNDANCY MEMORY STORAGE SYSTEM AND A METHOD FOR CONTROLLING A REDUNDANCY MEMORY STORAGE SYSTEM

(75) Inventors: John J. WUU, Ft. Collins, CO (US); Donald R. WEISS, Ft. Collins, CO (US)

(73) Assignee: ADVANCED MICRO DEVICES, INC., Sunnyvale, CA (US)

(21) Appl. No.: 12/985,139

(22) Filed: Jan. 5, 2011

(51) Int. Cl. G06F 11/20

(52) U.S. Cl. 714/6.21; 714/E11.084

(57) ABSTRACT

A memory system is provided, including a first memory comprising a plurality of bitcells configured to store data, and a second memory, configured to store an index of the data stored at a corresponding location in the first memory and further configured to store repair information, wherein the repair information indicates a bitcell error at the corresponding location in the first memory.

### TECHNICAL FIELD

The present invention generally relates to a memory system, and more particularly to a memory system with redundant memory.

### BACKGROUND

The amount of data capable of being stored in a fix amount of space has increased significantly in recent years. Improved circuit designs and better manufacturing techniques have reduced the size of the area on a semiconductor device where a single bit of data (i.e., a “0” or “1”) can be stored. This area, or cell, where a bit of data is stored, is sometimes known as a bitcell. Smaller bitcells allow for more data to be stored in the same amount of space. However, as bitcells have become smaller, atomic level imperfections in the semiconductor material have had an increasing effect on the functionality of the bitcells.

These imperfections may be introduced during the manufacturing process, in particular the doping process. Doping is the process of intentionally introducing impurities into a semiconductor to change its electrical properties. However, variations in the doping process, or other imperfections in the semiconductor material can cause random individual bitcells to fail, resulting in a random distribution of single-bit errors throughout the memory device.

### BRIEF SUMMARY OF EMBODIMENTS

In order to compensate for the random distribution of single-bit errors a memory system storing repair information and having a redundant storage or redundant area is used.

A cache is provided, including a data array comprising a plurality of bitcells configured to store data and a tag array, configured to store an index of the data stored at a corresponding location in the data array and further configured to store repair information, wherein the repair information indicates an error at the corresponding location in the data array.

A memory system is provided, including a first memory comprising a plurality of bitcells configured to store data, and a second memory, configured to store repair information, wherein the repair information indicates a bitcell error at the corresponding location in the first memory.

A method is provided, including retrieving, from a tag array in a cache system, repair information corresponding to a location of bitcells in a data array of the cache system, and correcting bitcells in the data array when the retrieved repair information indicates that an error is associated with the bitcells.

### BRIEF DESCRIPTION OF THE DRAWINGS

The present invention will hereinafter be described in conjunction with the following figures.

FIG. 1 illustrates an exemplary memory system in accordance with an embodiment;

FIG. 2 illustrates another exemplary memory system in accordance with an embodiment; and

FIG. 3 illustrates an exemplary method for handling bitcell errors in a memory system.

### DETAILED DESCRIPTION OF THE DRAWINGS

The following detailed description of embodiments is merely exemplary in nature and is not intended to limit the invention or the application and uses of the invention. Furthermore, there is no intention to be bound by any theory presented in the preceding background or the following detailed description.

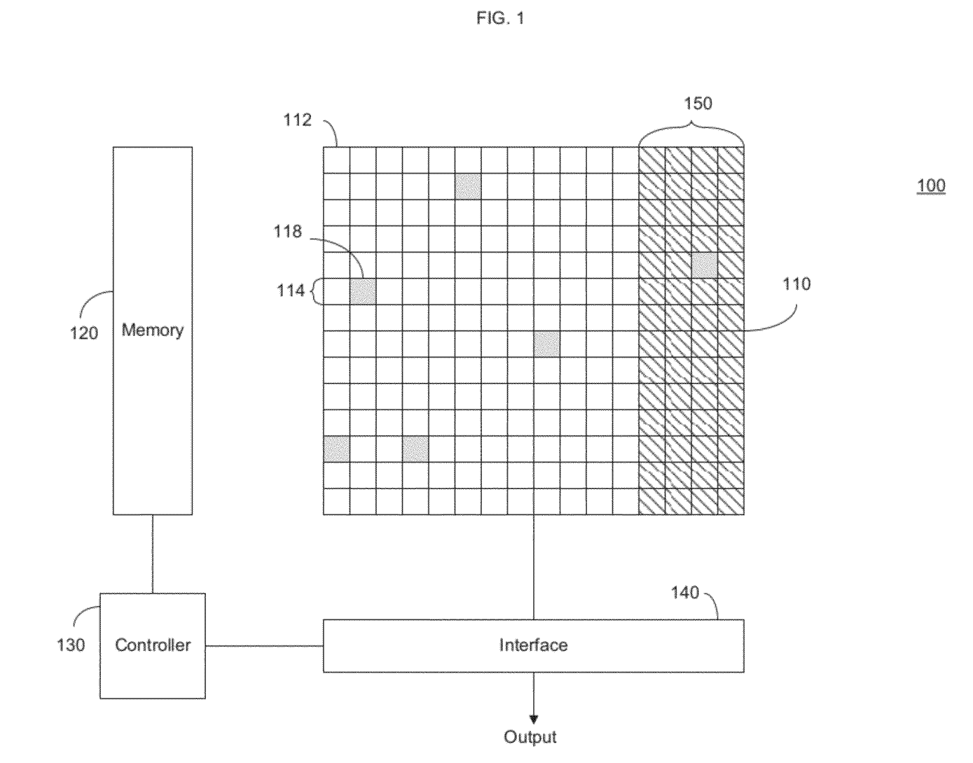

FIG. 1 illustrates an exemplary memory system 100 which includes a first memory 110, a second memory 120, a controller 130 and an interface 140. The first memory 110 and second memory may be based on any type of memory architecture known in the art. For example, the first memory and second memory could be a cache present in a processor, or they can also be standalone memories (i.e. not part of a cache). The first memory 110 may be a high capacity, low voltage memory which uses smaller bitcells as discussed above. While the first memory may be subject to the random single-bit doping errors, it has the advantage of being capable of storing large amounts of data in a small space and uses less voltage to retain data. The second memory 120 is preferably a memory which is less susceptible to random doping errors. The second memory 120 stores repair information and/or the location of bitcell errors corresponding to the first memory 110. The repair information can contain the location of the single-bit errors in the first memory no and/or instructions for repairing corresponding errors. The controller 130 and interface 140 manage the first memory no and second memory 120 and operate upon the repair information stored in the second memory 120, as discussed in further detail below.

In one embodiment, the first memory no may be, for example, a data array in a cache. The cache may be a computer processing unit (“CPU”) cache, a graphical processing unit (“GPU”) cache, a disk cache (e.g., a hard drive cache), a web cache or any other type of cache as is known in the art. The data that is stored within a cache might be values that have been computed earlier or duplicates of original data that are stored elsewhere. If requested data is contained in the cache (also called a cache hit), this request can be served by simply reading the cache, which is comparably faster than requesting the data from a traditional memory or recalculating the data.

Each block (e.g., block 112, etc.) illustrated in FIG. 1 represents a single bit in the first memory no. The first memory no may be addressed by line (e.g., row 114) or by word, a predefined portion of the line. Each line in the first memory no may be, for example, 512-bits or 1024-bits wide, however memories with other line widths could be used. The first memory may be accessed via a bus (not illustrated) in any manner as is known in the art. In some systems, the width of the bus which accesses the first memory no may have fewer bits than the line length of the first memory no. For example, the bus width may be 128-bits wide, but other bus widths can also be used. Accordingly, the first memory 110 may be addressed based upon the line and the respective portion (e.g., 128-bit portion) of the line (hereinafter referred to as a “word”).

The first memory no may be subject to the single-bit errors as discussed above. As seen in FIG. 1, the grayed out blocks (e.g., block 118) represent bits which are subject to random doping errors.

The second memory 120 stores repair information corresponding to the single-bit errors in the first memory 110. The second memory is preferably a type memory which is less susceptible to the single-bit errors. The second memory 120 can be part of the first memory 110 or it can be a separate memory. If the second memory 120 is part of the same memory as the first memory 110, the second memory 120 can be designed to use larger bitcells and/or have a larger access voltage to be more resistant to random doping errors.

In one embodiment, for example, the second memory 120 may be a tag array in a cache. A tag array is typically used to store an identification of the data stored in the data array of the cache. For example, if the cache is storing data which is also stored in another memory, the tag may store the location of the data in the other memory and a location of the data stored within the cache. If, for example, the cache is a CPU cache, the processor first accesses the tag array to located the data within the data array of the cache before requesting the data to be transferred from the cache to the processor via the bus. One advantage of using a tag array to store repair information, for example, is that the cache controller (e.g., CPU, GPU, etc) already accesses the tag array to locate the data being requested in the data array of the cache. Accordingly, in this embodiment, only a marginal amount of additional time is required to retrieve the repair information.

In one embodiment, the bitcells used in the tag array may be larger than the bitcells used in the data array of the cache. When a larger bitcell is used, the bitcell is less susceptible to random doping errors. Further, the voltage used to make changes to the data stored in the tag array may also be higher than the voltages used to make changes to the data stored in the data array. If a larger voltage is used to change the data stored in the tag array (i.e., second memory 120), the larger voltage is more likely to overcome any random doping effects which the bitcell may be subject to.

In another embodiment, the second memory 120 may be a static random access memory (“SRAM”). SRAM is a type of semiconductor memory where the word static indicates that, unlike dynamic RAM (DRAM), it does not need to be periodically refreshed, as SRAM uses bistable latching circuitry to store each bit. SRAM exhibits data remanence, but is still volatile in the conventional sense that data is eventually lost when the memory is not powered.

In yet another embodiment, the second memory 120 may be part of the first memory 110. For example, if the first memory no is a data array in a cache, a portion of the data array (i.e., the second memory 120) could be used for storing repair information.

In other embodiments, the second memory 120 may be a series of flip-flops, a field programmable gate array (“FPGA”), a random access memory (“RAM”) such as a synchronous RAM (“SRAM”), fuses, EEPROMs, eDRAMs or any other type of logic circuit capable of storing data.

As discussed above, the second memory 120 stores repair information. The size and type of the stored repair information can very depending upon the embodiment. For example, the location may indicate multiple lines (2, 3, 4 . . . n, n+1 . . . ), a single line, a portion of a line or by single bit in a line of the first memory no where an error is located. In other embodiments instructions for shifting or correcting bitcell errors may be stored.

In one embodiment, the second memory may store an encoded scheme for defining the location of the errors. For example, if the first memory uses a 512-bit wide line, with 128-bit words (i.e., the line has 4 words), the second memory could use a 2-bit encoding scheme to signify which word in the line contains an error bit. In one exemplary encoding scheme, “01” may indicated an error in the first word, “10” may indicate an error in the second word, “11” may indicate an error in the third word and “00” may indicate an error in the fourth word. One of ordinary skill in the art would recognize that different encoding schemes may be used. Further, the encoding scheme will depend upon how the location of the errors are delineated in the second memory 120 (e.g., by multiple lines, single line, word, bit, etc.) and the size of the first memory 110.

When a request to access, store or remove data in the first memory 110 is received, the controller 130 may retrieve or receive the stored information from the second memory 120.

In one embodiment, the information stored in the second memory 120 may be created at power-up using a built-in test. The controller 130 may attempt to store a series of predetermined or random bits in the first memory 110. The controller 130 can then read the state of the respective bit and compare the read state to an expected state. Based upon the results of the built-in test, the controller may store the repair information in the second memory 120.

In another embodiment the information stored in the second memory 120 may be generated on the fly. If an error occurs while the controller is accessing the first memory 110, the controller 130 can store the location of the error in the second memory. Accordingly, during a subsequent request to access the location where an error bit is located, the system would not suffer any penalties for correcting the error.

In yet another embodiment, if the second memory 120 is a non-volatile memory, the repair information stored in the second memory 120 may be pre-programmed or created once and referenced thereafter. For example, the first memory no may be subjected to a built-in test as described above. However, rather than repeating the test and storing the results each time the memory system 100 is powered up, the results could be stored in a non-volatile memory which would retain the repair information in memory even after the device looses power.

Any combination of the methods for storing information in the second memory 120 may also be used.

The controller 130 and the interface 140 can be used to correct or shift out defective bitcells. In one exemplary embodiment the first memory no may contain a word length redundant column, however, any number of redundant columns may be used. For example, as seen in FIG. 1, the last four columns 150 (i.e., the last word in each column in the exemplary embodiment) are designated for redundant bits. In this embodiment, where the first memory no is 4 words in length, the first 3 words are used to store data and the fourth word is used for supporting the error correction. While FIG. 1 illustrates the fourth word in each line as being designated for repair bits, any of the word length columns could be used for this purpose.

In one embodiment the interface 140 may include a series of multiplexors. The controller, based upon the information stored in the second memory 120, may correct or shift the data being read or written into the first memory 110 using the multiplexors as discussed in further detail below.

In other embodiments, single columns, rows, words or any other delineation of the first memory 110 may be designated for redundant bits. One of ordinary skill in the art would recognize that the interface 140 could be modified based upon where the redundant bitcells are located.

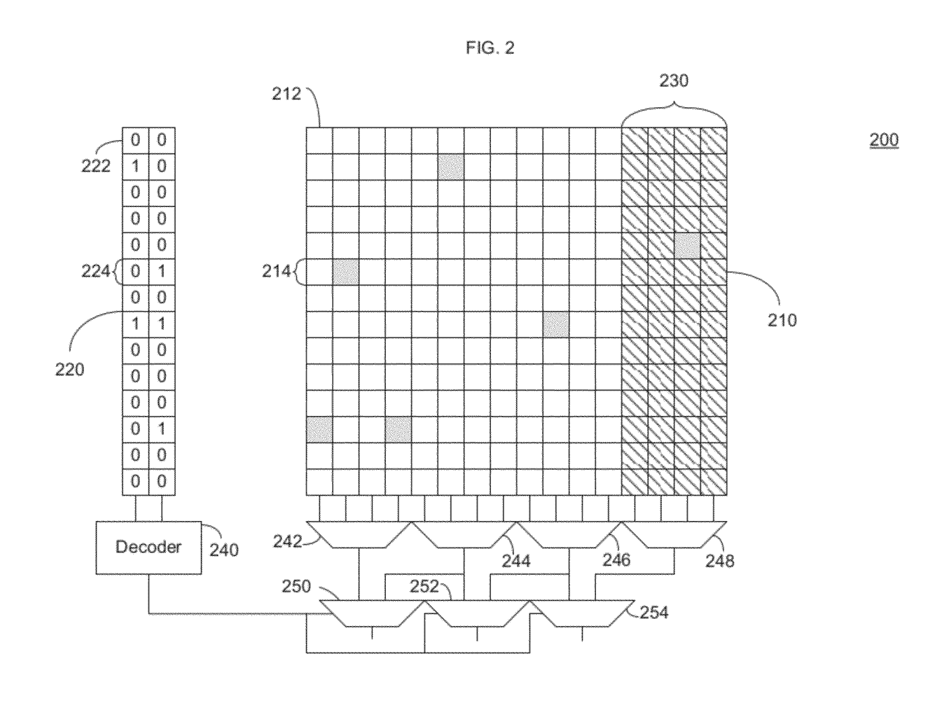

FIG. 2 illustrates an exemplary cache 200 and includes a data array 210 and a tag array 220. Each block (e.g., block 212, block 222, etc.) in the data array 210 and tag array 220 represents a single bit in the respective array. As discussed above, the cache 200 may be addressed by line (e.g., row 214) or by word. Each line in the cache may be, for example, 512-bits or 1024-bits wide, however caches with other bus widths could be used. The cache 200 may be accessed via a bus (not illustrated) in any manner as is known in the art. In the cache 200 illustrated in FIG. 2, each line is illustrated to be 16-bits wide to have 4-bit words for simplicity.

In the embodiment illustrated in FIG. 2, the bitcells in the last word 230 on each line is configured to be a redundant word. As discussed above, any of the words length areas of the data array 210 could be designated for redundant cells. Further, other redundant bitcell configurations could be used. For example, a single column could be designated for redundant bitcells. In other embodiments, multiple columns, a single line or multiple lines could be used. In another embodiment a third memory device could be used for redundant bitcells. The area for redundant bitcells can be selected based upon a density of the single-bit errors in the data array 210.

While the tag array 220 illustrated in FIG. 2 is only illustrated to have two bit length lines, the length of each line will depend on how the repair information is stored and the other information is stored in the second memory. As discussed above, the tag array also stores an index of the data stored in the data array. The tag array can also store coherency info (i.e. MESI bits), or other miscellaneous information.

The cache further includes a decoder 240 and a series of multiplexors (“MUXs”) 242-248 configured as column MUXs. In one embodiment, for example, MUXs 242-248 can be used to give an array a better aspect ratio. Column MUXs 242-248 also may allow a set of sense amplifiers and write circuitry to be shared between multiple bitcell.

In this exemplary embodiment, MUX 250 receives as input the first word and the second word, MUX 252 receives as input the second word and third word and MUX 254 receives as input the third word and fourth word. The decoder 240, based upon the coding scheme, selects which input is selected from MUXs 250-254.

TABLE 1

| Input | Output |
|---|---|
| 00 | 000 |
| 01 | 111 |
| 10 | 011 |
| 11 | 001 |

Table 1 illustrates the exemplary encoding/decoding scheme illustrated in FIG. 2. The input in Table 1 corresponds to the data stored in the tag array 220. The output in Table 1 corresponds to the input controls for MUXs 250, 252 and 254, respectively.

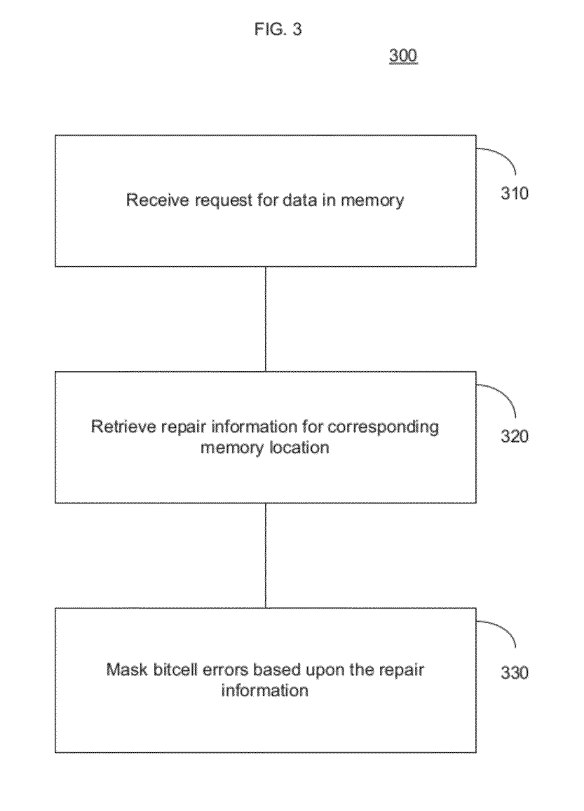

FIG. 3 illustrates an exemplary method 300 for controlling the cache 200 illustrated in FIG. 2. The cache 200 first receives a read request corresponding to the data array 210. (Step 310). The controller (i.e., CPU, GPU, etc.) then accesses the tag array 220 to locate the data within the data array 210 and to retrieve any repair information which may affect the read request. (Step 320). As discussed above, the repair information may be encoded using, for example, the encoding scheme illustrated in Table 1. The controller then decodes the repair information and, based upon the decoded repair information, corrects errors in the data array by routing the data request to known good cells. (Step 330). For example, if a read request for the data in line 214 was received (Step 310), the processor could locate line 214 based upon the index of data (not illustrated) in row 224 of tag array 220. While accessing row 224 of the tag array, the processor would also read the repair information located therein. (Step 320). In the exemplary embodiment illustrated in FIG. 2, the repair information is an encoded sequence of bits “01,” which indicates there is a bitcell with an error in the first word of line 214. The processor then decodes the repair information and determines how to correct the error. (Step 330). In this example, the processor would use the MUXs 250, 252 and 254 to read out data from the second, third and fourth words (i.e., the redundant word) in line 214 of the data array 210 to correct the bitcell error in the first word of line 214.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiments in any way. Rather, the foregoing detailed description will provide those skilled in the art with a convenient road map for implementing an exemplary embodiment. It being understood that various changes may be made in the function and arrangement of elements described in an exemplary embodiment without departing from the scope of the invention as set forth in the appended claims.

What is claimed is:

1. A cache, comprising:
a data array comprising a plurality of bitcells configured to store data; and
a tag array configured to store an index of the data stored at a corresponding location in the data array and further configured to store repair information indicative of an error at the corresponding location in the data array.

2. The cache of claim 1, further comprising a controller configured to receive the repair information stored in the tag array, the controller further configured to correct bitcells in the data array based upon the repair information.

3. The cache of claim 2, wherein the repair information is encoded based on a position of the error in the corresponding location.

4. The cache of claim 1, wherein the data array is configured to have a redundant column comprising a second plurality of bitcells.

5. The cache of claim 4, further comprising:
a plurality of multiplexors, each multiplexor configured to receive input from at least two bitcells in the data array, wherein at least one of the plurality of multiplexors is configured to receive input from a bitcell in the redundant column; and
a controller configured to select the output of the plurality of multiplexors based upon the repair information.

6. The cache of claim 1, wherein the repair information indicates an area of the corresponding location in the data array where a bitcell error exists.

7. The cache of claim 1, wherein the cache is configured to perform a built-in test at power-up to determine the repair information and to store the repair information in the tag array.

8. A memory system, comprising:
a first memory comprising a plurality of bitcells configured to store data; and
a second memory configured to store repair information indicative of a bitcell error at a corresponding location in the first memory.

9. The memory system of claim 8, further comprising a controller configured to receive the repair information stored in the second memory, the controller further configured to correct bitcells in the first memory based upon the repair information.

10. The memory system of claim 8, wherein the repair information is encoded based on a position of the error in the corresponding location.

11. The memory system of claim 8, wherein the first memory is configured to have a redundant area comprising a second plurality of bitcells.

12. The memory system of claim 11, further comprising:
a plurality of multiplexors, each multiplexor configured to receive input from at least two bitcells in the first memory, wherein at least one of the plurality of multiplexors is configured to receive input from a bitcell in the redundant area; and
a controller configured to select the output of the plurality of multiplexors based upon the repair information.

13. The memory system of claim 8, wherein the repair information indicates an area of the corresponding location in the first memory where the bitcell error exists.

14. The memory system of claim 8, wherein the first memory is configured to perform a built-in test at power-up to determine the repair information and to store the repair information in the second memory.

15. A method, comprising:
retrieving, from a tag array in a cache, repair information corresponding to a location of bitcells in a data array of the cache; and
correcting the bitcells in the data array when the repair information indicates that an error is associated with the bitcells.

16. The method of claim 15, further comprising storing, in the tag array, repair information corresponding to the bitcells in the data array.

17. The method of claim 16, wherein the storing further comprises using a built-it power up test to determine which of the bitcells in the data array have corresponding errors.

18. The method of claim 15, wherein the repair information is encoded and the retrieving further comprises decoding the repair information.

19. The method of claim 15, wherein the data array is configured to have a redundant area comprising a plurality of bitcells.

20. The method of claim 19, wherein the correcting further comprises shifting, when a corresponding word in the data array has a bitcell containing the error, a read or write request to the corresponding word in the redundant area in the data array.
